(19) United States
(12) Patent Application Publication
(10) Pub. No.: US 2007/0074579 A1
(43) Pub. Date: Apr. 5, 2007

(54) Wireless pressure sensor and method of forming same

(75) Inventors: James D. Cook, Freeport, IL (US); Alistair D. Bradley, Edinburgh (GB)

Correspondence Address: Kris T. Fredrick, Attorney, Intellectual Property;Honeywell International Inc., 101 Columbia Rd., P.O. Box 2245, Morristown, NJ, 07962, US

(73) Assignee: Honeywell International Inc.

(21) Appl. No.: 11/242,271

(22) Filed: Oct. 3, 2005

(51) Int. Cl. G01L 9/12

(52) U.S. Cl. 73/718

(57) ABSTRACT

A pressure sensor system includes a pressure sensing capacitor and an inductor integrated in a substrate. The pressure sensing capacitor includes a conductive diaphragm for detecting a pressure differential and an electrode separated from the diaphragm by a predetermined gap formed in the substrate. The inductor and pressure sensing capacitor form a passive inductive-capacitive (LC) tank circuit. A remote interrogation circuit, inductively coupled to the pressure sensor inductor coil, can be utilized to detect changes in resonant frequency of the LC tank wirelessly. The fully integrated pressure sensor structure is manufactured utilizing layer-by-layer fabrication techniques.

### TECHNICAL FIELD

Embodiments are generally related to sensors and, more particularly, to capacitance pressure sensors and methods of manufacturing such sensors. Embodiments are additionally related to disposable pressure sensors and wireless sensors for remotely sensing pressure. Additionally, embodiments are related to pressure sensors in the form of micro electro mechanical systems (MEMS) and methods of microstructure fabrication.

### BACKGROUND

In single-use type applications, such as for example medical systems and instrumentation, disposable sensors are required which can be implemented in a cost-effective manner. Typical pressure sensors are not particularly well suited to such applications by virtue of the relatively high number of component parts, expensive materials and/or processing requirements, and high number of manufacturing-processing teps required to both produce the sensors and to integrate them into the instrumentation or apparatus of the application.

In particular, wireless pressure sensors capable of operating passively without the need for a dedicated local power supply and associated circuitry are most promising candidates as disposable pressure sensors. Obtaining data from the sensor without wires reduces cost of sensor interconnects, makes integration of the sensor into the disposable/commodity part easier and improves disposal and/or interchangeability of the parts in the final application. Furthermore the lifetime of any non-disposable/multiple-use components is increased by removing the need to make and break mechanical electrical connections. Various devices have been proposed for use as passive wireless sensors, such as for example quartz surface acoustic wave (SAW) sensors, polyvinylidene fluoride (PVDF) acoustic wave sensors and inductance-capacitance (LC) resonator (tank) sensors. Typical quartz SAW sensors are capable of measuring pressure accurately but are generally expensive and can be unsuited to low pressure (˜1 bar) applications. PVDF acoustic wave sensors have been utilized to measure pressure but performance of this type of sensor is generally highly temperature and materials property dependent. LC resonator (tank) sensors, where the capacitance and/or inductance are capable of being varied, are employed for multiple sensing applications but current configurations present high materials and manufacturing cost.

There is a continuing need to provide sensors utilized in single use/disposable pressure sensing applications which can be manufactured and integrated into apparatus more efficiently and/or at lower cost. Similarly, low cost sensors are required to monitor pressure in commodity and consumer applications.

The embodiments disclosed herein therefore directly address the shortcomings of present pressure sensors providing a low cost disposable pressure sensor that is suitable for many price sensitive applications.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present invention to provide for improved pressure sensors and applications.

It is another aspect of the present invention to provide for a low cost pressure sensor.

It is a further aspect of the present invention to provide for a low cost disposable pressure sensor suitable for use in medical applications, such as for example extracorporeal blood monitoring and treatment apparatus.

It is an additional aspect of the present invention to provide for a method of forming a low cost pressure sensor.

The aforementioned aspects of the invention and other objectives and advantages can now be achieved as described herein.

According to one aspect, a pressure sensor system has a pressure sensing capacitor and an inductor integrated together in a substrate or housing. The pressure sensing capacitor has a diaphragm, made at least in part from a conductive material, integrated into or formed within the substrate, for detecting a pressure differential. Formed within the substrate is an electrode which is separated from the diaphragm by a predetermined gap formed in the substrate. The pressure sensing capacitor together with an inductor, also formed on or within the substrate, provide an LC tank circuit. When an electromagnetic signal is applied to the pressure sensor, the resonant frequency of the LC tank can be detected to enable determination of the pressure differential applied to the diaphragm.

By forming the pressure sensing capacitor and inductor within the same substrate, the number of components and manufacturing steps necessary to produce the sensor are reduced enabling a low cost wireless pressure sensor to be provided.

Furthermore, the pressure sensing capacitor and said inductor can be self-contained in said substrate thereby forming an integrated package ready for use. Consequently, no further packaging of the sensor is required, unlike in the case of conventional sensors in which the substrate or chip must be packaged before use.

Also on or within the same substrate are provided a surface for mechanical sealing to the pressure inducing media (pressure connector) and a means for exposing the sensor to a reference pressure for differential pressure measurement.

The inductor formed in conducting material, such as a metal layer, can be formed as a single layer coil rather than a multi-layer coil in order to reduce parasitic capacitance of the sensor. Also, utilizing a single layer coil further reduces the manufacturing steps necessary to produce the sensor and therefore the sensor costs.

The diaphragm can be in the form of a metal layer or sheet. Alternatively, the diaphragm can be in the form of a non-conductive sheet, such as a glass, ceramic or polymer sheet, having a conductive layer, such as a metal layer, formed thereon.

The metal layer or sheet utilized in forming the diaphragm can be made from Copper, Beryllium-Copper, Stainless Steel, Silver or Aluminum or other suitable metal or metal alloy.

The corresponding fixed electrode can also be in the form of a metal layer, such as for example a Copper (Cu), Aluminum (Al), or Silver (Ag) layer or other suitable metals or alloys thereof.

The diaphragm and/or electrode could also be plated with layer(s) or combinations of layers of Gold (Au), Nickel (Ni), Chromium (Cr), Silver (Ag) or other suitable metals or alloys thereof in order to enable high corrosion resistance and low resistance electrical connections.

The metal layer(s) or plating(s) can be formed by means of a metallization processes, such as for example physical vapor deposition. Alternatively for a ceramic based substrate metal loaded printing inks can be used to form the metallization.

A protective layer for chemically isolating the diaphragm from an external pressure inducing median can be disposed on the diaphragm. The protective layer can be formed integrally with build of the housing/substrate or as a separate layer formed on one or both sides of the diaphragm sheet before integration.

The substrate can be formed in a layer-by-layer fabrication process from a polymer, ceramic or other insulating material. If polymer is used to form the substrate, the substrate can be formed as a continuous structure by means of microstereolithography processing of photopolymer material. A layer of glass/ceramic or like non-conducting material can be included within the substrate to rigidify the substrate if necessary. If ceramic is used to form the entire substrate then the substrate can be formed as a continuous structure by means of screen printing process or by lamination of sheets of ceramic.

A calibration capacitor can be included on or within the substrate and electrically coupled to the pressure sensing capacitor so that the sensor can be calibrated/trimmed. The calibration capacitor can have a value selected on the basis of frequency versus pressure measurements to thereby reduce the pressure sensor sensitivity to a predetermined value. The calibration capacitor can be a laser trim capacitor which can be accordingly laser trimmed to the selected value.

An insulating region or layer can be arranged between the diaphragm and the electrode for limiting displacement of the diaphragm and preventing electrical shorting of the pressure sensing capacitor in the event of full or overpressure.

The sensor system can include an interrogation circuit for transmitting an interrogation electromagnetic signal to the inductor coil (inductive coupling) and determining the resonant frequency of the sensor LC tank. Such an interrogation circuit could comprise an antenna coil (loop) an oscillator and load detection circuitry.

In another aspect, a capacitance pressure sensor has a pressure sensing capacitor having a substrate formed as a continuous structure and a diaphragm for detecting a pressure differential, formed at least in part from a conductive material, integrated in the substrate. An electrode is also integrated in the substrate and separated from the diaphragm by a predetermined gap formed in the substrate. Also integrated in the substrate is an inductor, in the form of a single layer coil. The inductor and pressure sensing capacitor form an LC tank circuit. When an electromagnetic signal is applied to the pressure sensor, changes in resonant frequency of the LC tank can be detected to determine changes in a pressure differential applied to the diaphragm. The substrate can be made from polymer or ceramic in a layer-by-layer fabrication process.

In yet another aspect, a method of manufacturing a pressure sensor comprises forming a first portion of substrate material, forming an inductor coil on the first portion of substrate material, forming a second portion substrate material on the first portion of substrate material and the inductor coil, forming an electrode on the second portion of the substrate material, forming a third portion of substrate material on the second portion of the substrate material, the third portion being in the form of a step or shoulder arranged to form a predetermined gap adjacent the electrode, placing a conductive diaphragm on the third portion of substrate material, the diaphragm and the electrode being separated by the predetermined gap, forming a fourth portion of substrate material on the third portion of substrate material and the diaphragm such that the diaphragm is fixed to the third portion, the first, second, third and fourth portions of substrate material forming a substrate, forming a first conductive interconnect between the diaphragm and the inductor coil, and forming a second conductive interconnect between the electrode and the inductor coil.

The portions of substrate material can be formed by providing a photopolymer material, providing substrate photo masks for defining the portions, patterning light using the photo masks, exposing the photopolymer material to the patterned light to form the portions layer by layer.

The diaphragm can be formed from metal sheet and placed on the third portion.

The first and the second conductive interconnects can be formed by providing interconnect photo masks for defining open interconnect channels, patterning light using the interconnect photo masks, exposing the photopolymer material to the patterned light to form the portions with the open channels, depositing metal in the channels to form the first and the second conductive interconnects.

The electrode can be formed by depositing metal on the second portion. The inductor coil can be formed by depositing metal on the first portion.

The method of manufacturing the capacitance pressure sensor can include placing a trim capacitor on the underside of said first portion of substrate and electrically connecting the trim capacitor to the electrode and the inductor coil. In the case of using a laser trim capacitor, an additional portion of substrate material can be attached to the first substrate portion to encapsulate the trim capacitor with the exception of a window for laser access.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a perspective view taken from above of a pressure sensor according to a preferred embodiment;

FIG. 2 illustrates a perspective view of the pressure sensor of FIG. 1 with a segment of the sensor cut away;

FIG.3 illustrates a cross-sectional view taken along line A-A of the pressure sensor shown in FIG. 1;

FIG.4 illustrates a plan view of the pressure sensor of FIG. 1 with the electrode and trim capacitor omitted;

FIG. 5 illustrates an equivalent circuit diagram of the pressure sensor of FIG. 1 inductively coupled to the antenna coil (loop) of an interrogation unit;

FIGS. 6 to 14 illustrate cross-sectional views of the pressure sensor at various stages in the pressure sensor manufacturing process; and

FIG. 15 illustrates a cross-sectional view of a pressure sensor according to another embodiment.

### DETAILED DESCRIPTION OF THE INVENTION

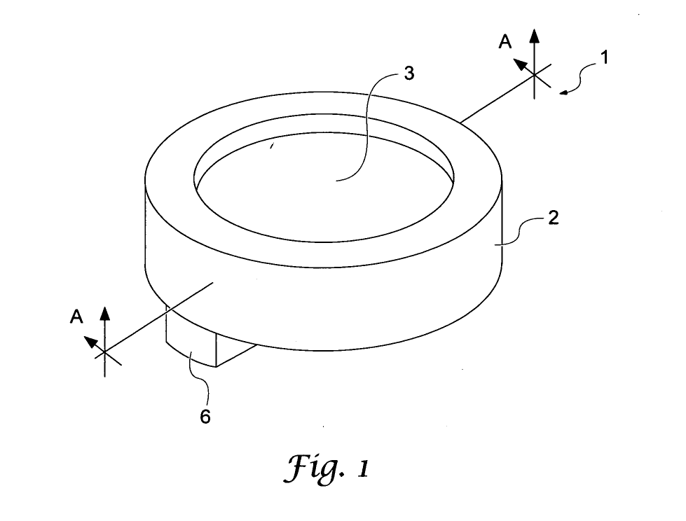

Referring to FIG. 1 of the accompanying drawings, which illustrates a perspective view of the pressure sensor in accordance with an embodiment, the pressure sensor 1 has a diaphragm 3 integrated in a substrate 2. In this particular embodiment, the pressure sensor has an annular configuration, however, those skilled in the art would understand that the sensor can have different shapes and forms.

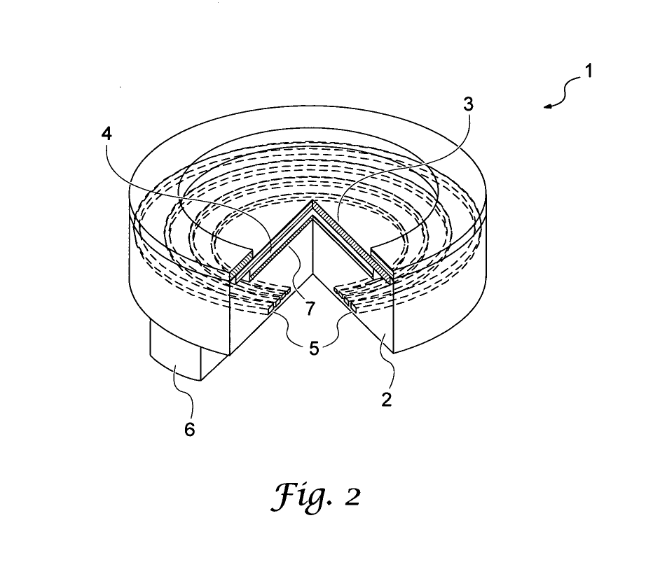

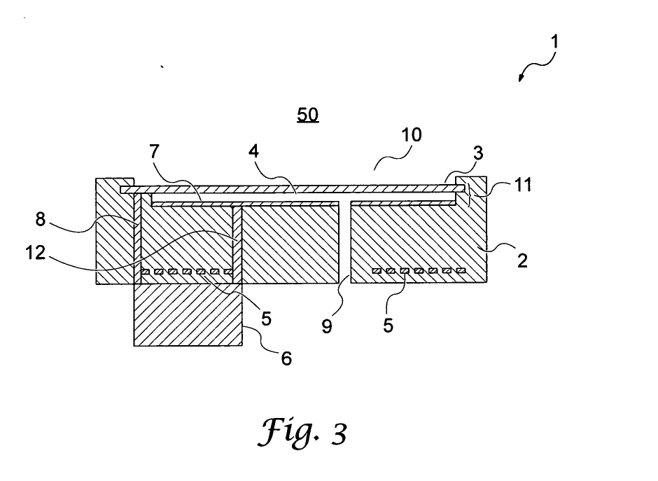

As best shown in FIG. 2, which illustrates the same view as FIG. 1 but with a segment of the sensor cut-away, and FIG. 3, which illustrates a cross-sectional view taken along line A-A of the sensor of FIG. 1, the diaphragm 3 is formed as a conductive layer or sheet which is fixed in a recess 10 formed in the uppermost part of the substrate 2. A fixed electrode 7 is also located in the recess beneath and concentric with the diaphragm and spaced apart therefrom such that a predetermined air gap or cavity 4 separates the diaphragm from the electrode. A through channel or hole 9 formed in the substrate connects the cavity 4 to atmosphere.

The diaphragm 3, electrode 7 and predetermined air gap or cavity 4 therebetween together form a pressure sensing capacitor 11 in which a change in the differential pressure between the cavity and an external pressure inducing medium 50 alters deflection of the diaphragm and therefore changes the capacitance between the fixed electrode and the diaphragm.

An inductor coil 5, formed in the substrate 2, is spaced from and electrically interconnecting the pressure sensor capacitor 11 by means of an outer conductive interconnect 8, which connects the diaphragm 3 to the outer end of the coil, and inner conductive interconnect 12, which connects the inner end of the coil to the electrode 7. FIG. 4 illustrates a plan view of pressure sensor 1 showing the coil 5 and diaphragm 3 with the electrode 7 and trim capacitor 6 omitted for clarity. As will be described in more detail below, the pressure sensor capacitor 11 and inductor 5 together form an LC tank which can be inductively coupled to an associated interrogation circuit for remotely detecting changes in the pressure differential between the cavity 4 and external medium 50.

By forming the pressure sensing capacitor 11 and inductor 5 on or within the same substrate 2, the number of components and manufacturing steps necessary to produce the sensor are reduced enabling a low cost wireless pressure sensor to be provided.

The substrate 2 is formed from a polymer which material lends itself to micro fabrication. Alternative substrate materials can be used which are sufficiently rigid to prevent distortion of the cavity 4 upon mounting the pressure sensor 1 and which can provide the necessary electrical isolation between parts of the pressure sensing capacitor 11 and inductor 5. For example, a ceramic or other insulating material including a semi-conductor could be used as the substrate material instead of polymer. When polymer is used, the thickness should be about 1 mm or more to provide the necessary rigidity. Alternatively or additionally, the substrate can include a layer of glass or other similar material to increase stiffness.

The diaphragm 3 in this embodiment consists of a plate formed by photo etching thin rolled sheet. of metal such as Copper, Beryllium-Copper, Stainless-steel (e.g. 17-7PH), Aluminum or alternatives. The diaphragm sheet must have a diameter greater than the diameter of the cavity 4. Alternatively, the diaphragm could be formed from a glass layer or other insulating material layer with a conductive layer, such as metal, disposed thereon.

For the embodiment shown in FIG. 1, the dimensions of the diaphragm for a given material or material combination can be selected such that the diaphragm has sufficient stiffness to deflect by an amount less than the cavity thickness at the maximum pressure differential for which a sensor response is required. For example, a metal diaphragm of about 5 mm in diameter should have a thickness of about 100 microns based on a cavity thickness of about 10 μm with an operating pressure range of around +1 to −1 barg. In order to enable low resistance electrical connection to the diaphragm, the conductive layer could be plated with Au, Ni, Cr, Ag, alternatives or combinations.

An additional thin layer (not shown) of polymer or other insulating material can be formed between the diaphragm 3 and electrode 7 to prevent shorting at full scale pressure or with overpressure. For example, the additional layer can be formed on the upper surface of the electrode.

In this particular embodiment, the inductor 5 is designed as planar coil placed coaxially with the diaphragm so as to enable ease of manufacture, smallest overall dimensions and ease of alignment with interrogation antenna. The coil is formed as a single layer embedded in the substrate 2 to minimize parasitic capacitance. Also, utilizing a single layer coil further reduces the manufacturing steps necessary to produce the sensor and therefore the sensor costs. However, the coil could instead take the form of multiple layers and/or could be disposed on the surface of the substrate.

In the embodiment of FIG. 1, the diaphragm 3, electrode 7, inductor coil 5, and electrical interconnects 8,12 are self-contained withinin the substrate so that the substrate itself functions as the sensor housing thereby forming an integrated package ready for use. Consequently, no further packaging of the sensor is required, unlike in the case of conventional sensors in which the substrate or chip must be packaged before use.

The pressure sensor 1 can be fabricated by means of various micro fabrication processes, such as for example by means of layer-by-layer deposition processes as in microstereolithography and printing of polymer materials, or in printing of ceramic materials or utilizing microfabrication techniques used in the field of semiconductor technology.

Rapid prototyping is widely used in automotive and aerospace industries and other technical fields requiring manufacturing of three dimensional prototypes. In particular, microstereolithography machines are utilized to build small-size, high-resolution, three-dimensional objects, by superimposing a specified number of layers obtained by light-induced and space-resolved polymerization of liquid resin into a solid polymer. Non-limiting examples of microstereolithography are provided in “Microstereolithography: a Review”, Arnaud Bertsch et al, Material Research Society Symp. Proc. Vol. 758, 2003, pg. LL1.1.1-13.

Preferred methods for high volume manufacture are techniques based on an “integral” microstereolithography approach whereby liquid monomer is selectively hardened, layer-by-layer, by exposure to light through a mask or dynamic pattern generator. In integral microstereolithography, every layer of the object is made in one irradiation step by projection of its image on the photopolymerizable resin rather than by fine focusing of a light beam in one point as in vector-by-vector microstereolithography processes. A pattern generator or photo mask shapes the light such that it can contain the image of the layer to be solidified. Superposition of the different layers composing the object is done in the same manner as in stereolithography.

As will be described in more detail below, in order to fabricate the pressure sensor 1 according to one embodiment commercially available manufacturing processes based upon microstereolithography are utilized. In particular the stepwise growth of the polymer structure is interrupted to place each component, in this case the diaphragm and, if necessary the surface mount trim capacitor, and polymerization of liquid monomer is subsequently continued to seal each component into the structure. In addition the stepwise growth is interrupted to allow the formation of interconnects, the electrode and coil by metal deposition.

One microstereolithography technique for fabricating the pressure sensor is Rapid Micro Product Development RMPD™ developed by microTEC GmBH, Germany, in which a “RMPD-mask” is employed along with 3D Chip-Size-Packaging (3D-CSP).

DE4420996C2, entitled “Mfg. micro-mechanical and micro-optical components”, published Apr. 19, 1998 to Reiner Goetzen, and which is incorporated herein by reference, details procedures, with which between two parallel plates, at least one of which is permeable to electromagnetic waves, and a small quantity of liquid light-hardenable plastic is held due to the surface tension. The surface of the plastic liquid underneath the plate permeable to electromagnetic waves is illuminated for example by means of laser beam through the permeable plate, whereby the laser beam is directed across the surface in accordance with sections taken from a 3D computer generated model of the structure. Layer by layer the laser light hardens the plastic liquid according to the 3-D layer model, whereby the distance of the plates is increased in each case around a layer thickness, so that fresh plastic material can flow due to surface tension alone into the developing gap between the hardened layer and the plate. In this way structures within the micrometer range can be accurately produced.

The general procedure for mechanical and electrical connecting of system components by layer-wise solidification of a liquid, light-hardenable plastic is already well known from DE 195 39 039 C2, entitled “Improved manufacture of micro-mechanical and micro optical devices”, published Nov. 11, 1999 to Reiner Goetzen and incorporated by reference herein.

DE19826971C2, entitled “Mechanical and electric coupling integrated circuits”, published Mar. 14, 2005 to Reiner Goetzen et al., also incorporated herein by reference, concerns a procedure for mechanical and electrical connection of system component parts like integrated circuits (ICs) and further active/passive electronic as well as mechanical system component parts for the production a complex electronic, electro-optical, electro-acoustic or electro-mechanical system by layer-wise solidification of a liquid, light-hardenable plastic, whereby during the layer-wise fabrication of the module recesses are generated for the admission of the system component parts as well as connection channels for the admission of electrically conducting connections between the embedded system component parts.

According to the procedure described in DE19826971C2, first by layer-wise solidification of the liquid, light-hardenable plastic, a basis module with a recess is produced for the admission of a system component part in the form of an IC. Next, the IC is inserted into the recess and locked by further layer-wise structure of the basis module in accordance with the above-mentioned procedure so that the IC is embedded. Connection channels are generated at the same time from the mating surfaces (bond surfaces) of the IC to the surface of the basis module. These bond surfaces can be arranged arbitrarily on the chip and have a size of approximately 20 μm×20 μm.

In the further procedure of DE19826971C2, the highest surface of the basis module generated so far is coated with an electrically conducting material by evaporating, for example by vapor deposition, whereby the walls of the channels leading to the bond surfaces are likewise coated, so that an electrical connection to the bond surfaces is made. Masks for the conductive channels are produced likewise by layer-wise solidification of the liquid, light-hardenable plastic. By for example plasma corroding, the conductive strip masks are removed completely and the surrounding leading material at least partly removed.

In the further process of the procedure of DE19826971C2, the existing basis module is built up layer-wise, whereby again at least one recess for the admission of one or several components are created, and at the same time the necessary bond channels are generated. After inserting the appropriate components into the recess and/or recesses the module is further built up layer-wise, whereby the recesses are locked and the components are embedded.

Another example of the RMPD™ fabrication process can be found in U.S. Pat. No. 6,805,829 B2, “Method for production of Three-Dimensionally arranged conducting and connecting structures for volumetric and energy flows”, issued to Reiner Gotzen on Oct. 19, 2005, which is incorporated herein by reference.

Materials used for RMPD™ are either Acrylates (specifically Poly(methyl methacrylate)—PMMA) or Epoxies. For this design such materials should be selected with high Young's modulus for rigid substrate structure and also for good adhesion properties with the diaphragm and metallization material.

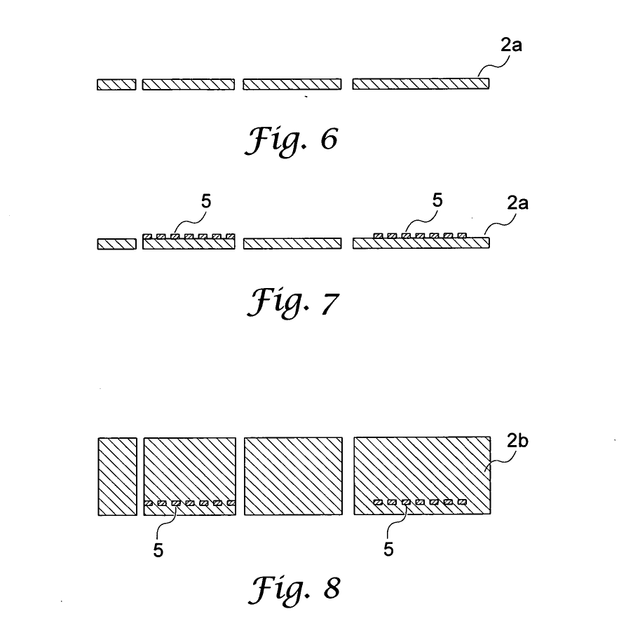

A method of fabricating the pressure sensor 1 using microfabrication technology according to one embodiment will now be described with reference to FIGS. 6 to 14.

Initially, a 3D CAD model is generated including sliced 2D layers to define photo masks required for UV exposure and to set the thickness of the polymer and metal layers to be grown. A dynamic pattern generator might be used instead of photo masks.

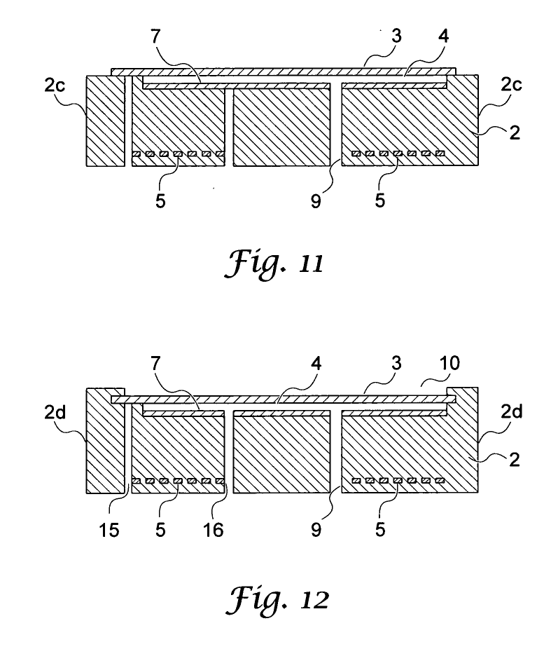

Initially, the photo polymerization process is performed by exposing photopolymer to light patterned by the photo masks to grow the lowermost portion 2a of the housing or substrate which portion is shown in cross-sectional view in FIG. 6. The photo mask leaves interconnect channels 15,16 and a through hole channel 9 open (See FIG. 12). In the example shown in FIG. 6, the substrate has a diameter of 6 mm and is grown using a rigid photopolymer having a Young's modulus of about 3000 MPa.

Once the lowermost portion 2a is grown, the polymerization process is interrupted so that the inductor coil 5 can be formed on the upper surface of the portion 2a by means of a metallization process, such as for example, physical vapor deposition using a patterning mask. The coil is designed to provide a suitable resonant frequency, f, where f is inversely proportional to 2π.√LC, low parasitic capacitance, and high quality factor Q value where Q is inversely proportional to R.√C/L. In this particular example, the coil is formed as a single copper layer having a 4.5 mm diameter, 11 turns, 30 μm track spacing, 60 μm track width and 15 μm thickness such that a suitable inductor value ˜500 nH is achieved for the sensor operating in the frequency range 50-100 MHz. FIG. 7 illustrates a cross-sectional view of the substrate portion 2a following formation of the coil by the metallization process.

Thereafter, the polymerization process is resumed such that polymer layers are superimposed on the substrate portion 2a and coil 5 thereby embedding the coil in the substrate while leaving the interconnect channels open.

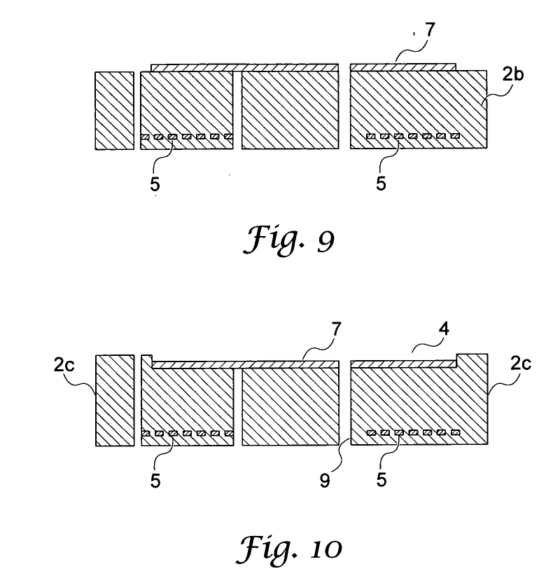

The polymerization process is continued forming a second substrate portion 2b leaving the interconnect and vent channels open as illustrated in FIG. 8. Following formation of substrate portion 2b, the polymerization process is again interrupted, this time to enable formation of the electrode 7 on the upper surface of the substrate portion 2b concentric with the coil as depicted in FIG. 9. In the example of FIG. 9, the electrode is formed by deposition of a 5 μm thick copper layer. Masking is used during the metallization process to leave the through channel (vent) open.

Subsequent to formation of the electrode 7, the polymerization process is resumed using a photo mask to form an annular step 2c on the periphery of the substrate portion 2b thereby defining a recess or cavity 4 in the substrate above the electrode 7 as shown in FIG. 10. If necessary, preparatory to formation of the annular step 2c, the polymerization process can be continued above the entire electrode 7 to form an insulating layer (not shown) to prevent shorting between the diaphragm 3 and electrode in cases in which high positive pressure is applied to the diaphragm. Such a layer can also act as mechanical overpressure stop limiting sensitivity increase and mechanical stress in the diaphragm and polymer-diaphragm interface as the diaphragm displaces towards the electrode.

Thereafter, the polymerization process is once again interrupted so that a metal diaphragm 3 can be placed on the substrate concentric with the electrode 7. The diaphragm periphery is supported on the annular step 2c such that an air gap exists between the electrode 7 and the diaphragm as shown in FIG. 11. The gap is predetermined by the height of the annular step 2c. In the example shown in FIG. 11, the gap is 10 μm thick and has a 4.4 mm diameter.

The diaphragm 3 can be formed by stamping or by photo etch to form large area arrays of multiple diaphragms loosely connected. Forming arrays of diaphragms permits manufacture of the pressure sensor 1 in batch or continuous line reel-reel processes. The diaphragm can be formed from rolled metal sheet. A photo etch process can be used on the sheet to form an array of metal diaphragms connected by narrow strips of same metal enabling easy singulation after sensor manufacture. Appropriate force can be applied to areas of the sheet during manufacture in order to ensure intimate contact between all areas of diaphragm circumference and the annular step. 2.

In the example shown in FIG. 11, a Copper-Beryllium diaphragm is used having a 5.1 mm diameter, 71 μm thickness and a tab for interconnection to the outer interconnect 8.

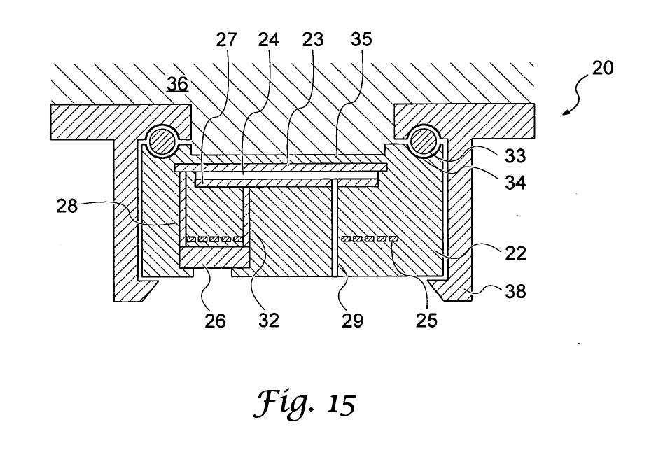

Subsequent to placement of the diaphragm 3, the polymerization process is resumed yet again building layers on the annular step to secure the diaphragm periphery in the substrate forming an uppermost substrate portion 2d which provides a mounting surface for sealing to a pressure vessel or like component (See FIG. 12). For example, the substrate can be bonded by flexible epoxy to a chamber in which pressure is being measured thereby forming a simple pressure connection. Alternatively, an ‘O’ ring seal can be used to seal the pressure sensor to a fluid housing, for example as shown in FIG. 15.

If required, a protective region (not shown) for additional media isolation can be formed above the diaphragm 3 to isolate the diaphragm from the media. The protective region could be formed by the polymerization process using the same polymer as the rest of the substrate, or alternatively, a different polymer or silicone rubber. Alternatively or additionally, a coating such as for example, parylene, silicone, PTFE (Teflon), can be formed on the diaphragm.

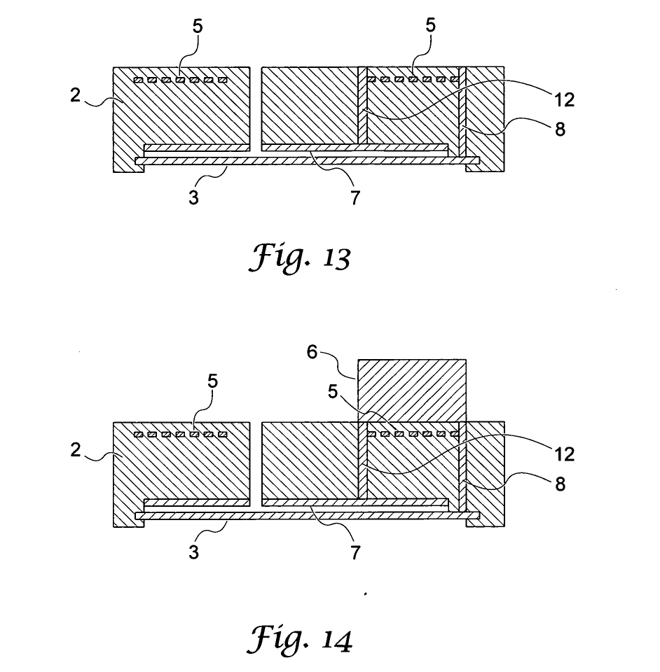

Once the substrate portion 2d is built and any protective region has been formed, the substrate is flipped over so that the outer and inner interconnects 8, 12 can be provided in the form of conductive vias by metallization of the open interconnect channels 15, 16 (see FIG. 12.). The resulting structure after interconnect formation is shown in cross-sectional view in FIG. 13. Thereafter, surface mount pads (not shown) are deposited on the substrate connecting with the interconnects 8,12.

A surface mount laser trim capacitor 6 can then be mounted on the pads and metallization applied to electrically connect the pads and capacitor as shown in FIG. 14. Polymer layers (not shown) could then be built up using the polymerization process to integrate the laser trim capacitor, leaving window for laser trimming during calibration as will be explained in more detail below.

Correction for offset/null variation, governed primarily by air gap variation, also parasitic capacitance and inductance variation, and sensitivity variation, governed primarily by diaphragm thickness tolerance and air gap variation, is required for interchangeability of high volume disposable sensors. One preferred method of null correction is simply to measure the sensor resonant frequency at atmospheric pressure, 0 bar g, immediately before measurement of unknown pressure in the application and thus apply the measured offset to suitable compensation algorithm in an interrogation circuit, i.e. a single point correction or auto-zero. For sensitivity correction, i.e. two point correction, which cannot be provided in the application environment, the discrete trim capacitor 6 is required.

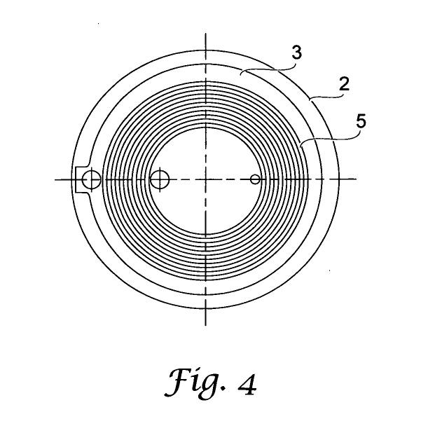

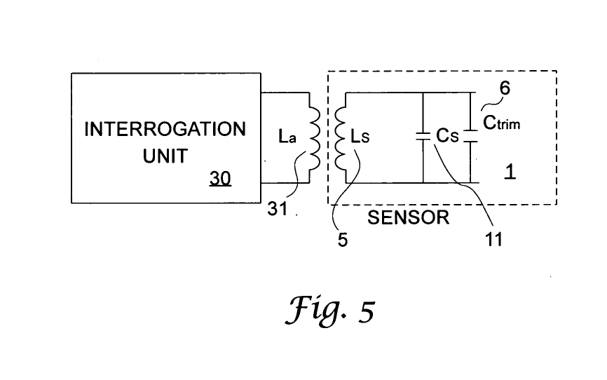

Referring to FIG. 5, which illustrates the trim capacitor 6 with electrical circuit arrangement of the pressure sensor of FIG. 1 and a reader antenna 35 of an associated interrogation unit 30. The trim capacitor 6, electrical connected in parallel with the pressure sensing capacitor 11, has a value selected on the basis of frequency versus pressure measurements taken during manufacture to reduce the sensitivity to a predetermined value which can be known by the interrogation unit.

It will be apparent to those skilled in the art that other means of calibration/trim correction could also be employed including but not limited to storage of sensitivity and/or offset calibration factors as optical barcode or RFID device or similar digital wireless device. With such correction, temperature effects might also be included for improved accuracy over wider operating conditions.

In the method of manufacturing the pressure sensor 1 shown in FIGS. 6 to 14, the pressure sensor is calibrated by applying known pressures and measuring the sensor output. The laser trim capacitor 6, such as for example a LASERtrim™ chip capacitor from Johanson Technology Inc, can be trimmed using a laser until the required output is provided. Alternatively, preparatory to mounting the capacitor 6 on the substrate, the pressure sensor can be calibrated by applying known pressures, measuring the output and calculating the capacitance required to give desired sensitivity. The capacitor with required capacitance can then be selected and soldered to the substrate. If required a range of predetermined sensitivity values could be targeted and the appropriate range could be selected by the interrogation circuit according to the frequency measured at atmospheric pressure.

In order to complete fabrication of the pressure sensor 1, a passivation layer (not shown) can be applied to the substrate (e.g. parylene, silicone, PTFE (Teflon) coating) for environmental isolation of trim capacitor and interconnects.

The pressure sensor 1 can be fabricated using other RMPD™ methods, for example, the substrate could be formed by the polymerization process without forming the cavity 4 and through hole 9. Instead a “RMPD-multimat” process can be utilized in which the cavity 4 and through hole 9 are formed by first depositing a second type of polymer in these regions which is preferentially removed by a chemical etchant or solvent.

In a method of manufacturing the pressure sensor according to yet another embodiment, the pressure sensor 1 is formed using alternative materials of ceramic and metal loaded inks such as those used in low temp co-fired ceramics technology (LTCC). One non-limiting example of such ceramic fabrication technology is provided in U.S. Patent Application Publication No. 2005/0040988A1, entitled “LTCC-Based Modular MEMS Phased Array”, to Amir I. Zaghloul, which was published on Feb. 24, 2005 and which is incorporated herein by reference. A further non-limiting example of a suitable high-volume manufacturing method for ceramic based structure is that of High-Volume Print Forming (HVPF ™) described in U.S. Patent Application Publication No. 2004/0170459A1, entitled “High Volume Print-Forming System”, to Taylor et al, which was published on Sep. 2, 2004 and which is incorporated herein by reference. HVPF™ is being provided by EoPlex Technologies, Inc, 3698-A Haven Avenue, Redwood City, Calif. 94063. In this case the cavity and reference to atmosphere can be formed from a second sacrificial (or “negative”) material which is selectively removed after all other layers of the housing and metallization are complete.

A method of operating the pressure sensor 1 for measuring the differential pressure between the external median 50 and cavity 4 will now be described with reference to FIGS. 1 & 5. When the pressure sensor is located in its operating position, an interrogation electromagnetic signal is transmitted from a reader antenna 31 of the interrogation unit 30 to the inductor coil 5, preferably perpendicular to the plane of the coil so as to induce a unidirectional current therein. The coupling impedance of the sensor LC circuit to the reader antenna coil 31 is analyzed by the interrogation unit to remotely detect the resonant frequency of the sensor LC circuit. One non-limiting example of such an interrogation unit would employ a grid-dip oscillator circuit to enable determination of the sensor resonant frequency. Changes in the capacitance of the pressure sensing capacitor 11 induced by changes in the differential pressure between the cavity 4 and external median 50 are remotely detected by the interrogation unit as corresponding changes in resonant frequency. Obtaining data from the pressure sensor without wires variously reduces the cost of the sensor, makes integration of the sensor into the disposable/commodity part easier and cheaper, improves disposal and/or interchangeability of the parts in the final application and furthermore increases the lifetime of any non-disposable/multiple-use components by removing the need to make and break mechanical electrical connections.

FIG. 15 illustrates a cross-sectional view of a pressure sensor 20 according to another embodiment. The pressure sensor 20 is similar to the pressure sensor 1 in that it has a substrate 22, diaphragm 23, electrode 27, cavity or gap 24, conductive interconnects 28 and 32 and trim capacitor 26 arranged in a similar manner to like elements of the pressure sensor of FIG. 1. However, in this embodiment, trim capacitor 26 has been integrated into the substrate by the layer-by-layer polymerization processes. In addition a protective region 35 for additional media isolation is formed above the diaphragm to isolate the diaphragm 23 from the median 36. The protective region 35 is integrally formed in the substrate 22 by the polymerization process using same or alternative polymer from the rest of the substrate 22. An annular groove 34 is formed by the polymerization process in the upper surface of the upper most substrate portion providing seating for an ‘O’ ring 33 for sealing the sensor to a fluid housing with integral clip 38. Alternatives methods of sealing the sensor to a fluid housing could also be used—e.g. secure with adhesive, flexible epoxy, ultrasonic weld, laser weld etc. As a further alternative the sensor might be contained within the media 36 and a seal made to the bottom surface to expose the vent 29 to atmosphere while the upper surface of the diaphragm 23 experiences the media 36 pressure as before.

The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered.

1. A pressure sensor system comprising:
a pressure sensing capacitor comprising:
a substrate or housing
a diaphragm, formed on or held within said substrate, for detecting a pressure differential, said diaphragm comprising a conductive material, and
an electrode formed on or within said substrate, said electrode being separated from said diaphragm by a predetermined gap formed in said substrate, and
an inductor formed on or within said substrate, said Inductor and said pressure sensing capacitor forming an LC tank circuit,
whereby, when an electromagnetic signal is applied to the pressure sensor, changes in resonant frequency of said LC tank can be detected to determine changes in a pressure differential applied to said diaphragm.

2. The system of claim 1, wherein said pressure sensing capacitor and said inductor are self-contained in said substrate thereby forming an integrated package ready for use.

3. The system of claim 1, wherein the inductor comprises an inductor coil formed as at least one layer on or within said substrate.

4. The system of claim 1, wherein said diaphragm further comprises a metal layer or plate and optionally a glass layer or plate.

5. The system of claim 4, further comprising: a protective layer for protecting said diaphragm from a pressure inducing median, said layer being formed integrally in said substrate or as a separate layer formed on said diaphragm.

6. The system of claim 1, wherein said substrate is formed from a polymer or ceramic.

7. The system of claim 6, wherein said substrate is a continuous structure formed by means of microstereolithography of photopolymer material.

8. The system of claim 6, wherein said substrate is a continuous structure formed by means of ceramic printing.

9. The system of claim 1, further comprising: a calibration capacitor attached or integrated into said substrate and electrically coupled to said pressure sensing capacitor, said calibration capacitor having a value selected on the basis of frequency versus pressure measurements to thereby reduce the pressure sensor sensitivity to a predetermined value.

10. The system of claim 1, further comprising: an insulating region or layer arranged between said diaphragm and said electrode to limit range of deflection of said pressure sensing capacitor in the event of full or overpressure.

11. The system of claim 1, wherein said sensor is formed by means of a Rapid Micro Product Development (RMPD™) processes.

12. The system of claim 1, including an interrogation circuit for transmitting an electromagnetic signal to said inductor and for analyzing the resonant frequency of said pressure sensor LC (tank) circuit.

13. A capacitance pressure sensor comprising:
a pressure sensing capacitor comprising:
a substrate formed as a continuous structure,
a diaphragm, integrated in said substrate, for detecting a pressure differential, said diaphragm comprising a conductive material, and
an electrode integrated in said substrate, said electrode being separated from said diaphragm by a predetermined gap formed in said substrate, and
an inductor formed as at least one layer of coil integrated in said substrate,
said inductor and said pressure sensing capacitor forming an LC tank circuit,
said pressure sensing capacitor and said inductor being self-contained in said substrate thereby forming an integrated package ready for use,
whereby, when an electromagnetic signal is applied to the pressure sensor, changes in resonant frequency of said LC tank can be detected to determine changes in a pressure differential applied to said diaphragm.

14. The pressure sensor of claim 13, wherein said substrate comprises polymer or ceramic.

15. The pressure sensor of claim 13, wherein said sensor is formed from polymer by means of a Rapid Micro Product Development (RMPD™) processes.

16. (cancaled)

17. (canceled)

18. (canceled)

19. (canceled)

20. (canceled)
